(19) United States
(12) Patent Application Publication
(10) Pub. No.: US 2003/0125474 A1
(43) Pub. Date: Jul. 3, 2003

(54) Rubber composition

(76) Inventor: Fumito Yatsuyanagi, Hiratsuka-shi (JP)

Correspondence Address: David T. Nikaido, RADER, FISHMAN & GRAUER, PLLLC, Suite 501, 1233 20th Street, NW, Washington, DC, 20036, US

(21) Appl. No.: 10/173,656

(22) Filed: Jun. 19, 2002

(30) Foreign Application Priority Data
Jun. 27, 2001 (JP) 2001-195140
Mar. 29, 2002 (JP) 2002-094587

(51) Int. Cl. C08F 136/00

(52) U.S. Cl. 525/331.9; 524/525; 525/342

(57) ABSTRACT

A rubber composition of (i) 100 parts by weight of a starting rubber of (A) 40 to 120 parts of SBR and carbon black (CB) having an N₂SA of at least 70 m²/g, (B) 40 to 120 parts by weight of an NR-CB rubber composition of NR and CB having an N₂SA of at least 70 m²/g, and (C) BR and/or SBR having a Tg higher by at least 10° C. than that of the SBR in the SBR-CB rubber composition (A), wherein the rubber composition has a ratio of the average value F_{MB} of the concentration of CB to the amount of rubber in the CB-containing rubber compositions (A) and (B) and the concentration F_{COM} of CB to the amount of rubber in the rubber composition of 1.2 to 3.0. In addition a rubber composition containing a CB-containing natural rubber master batch obtained by mixing a natural rubber (NR) starting latex and carbon black (CB) in a water-based medium and coagulating and drying it, an additional starting rubber having a glass transition temperature (Tg) of −50° C. to −20° C. and silica in an internal mixer.

### BACKGROUND OF THE INVENTION 1. Field of the Invention

The present invention relates to a rubber composition obtained by mixing a master batch of a styrene-butadiene copolymer rubber (SBR) and carbon black (CB) and a natural rubber (NR) and carbon black (CB) master batch with a starting rubber having a Tg higher than that of the above SBR in a specific ratio in an internal mixer. More particularly, it relates to a rubber composition having an improved temperature dependency of the tan δ and greatly improved abrasion resistance, tensile strength, elongation at break, etc., which is not obtainable with a master batch of only a conventional SBR system, and suitable, for example, for use in a pneumatic tire.

The present invention also relates to a rubber composition having a superior abrasion resistance, rolling resistance, and resilience obtained by mixing a carbon black (CB)-containing natural rubber master batch obtained by mixing a natural rubber (NR) latex and CB in a water-based medium followed by coagulating and drying the same with an additional starting rubber having a specific high glass transition temperature (Tg) and silica.

2. Description of the Related Art

Various proposals have been made for obtaining a rubber composition having improved physical properties such as viscoelasticity by blending carbon black into rubber by various methods. For example, Japanese Unexamined Patent Publication (Kokai) No. 9-67469 discloses a method of dividedly adding carbon black to end-modified low Tg rubber and high Tg rubber. Japanese Unexamined Patent Publication (Kokai) No. 9-324077 discloses the use of a wet master batch of carbon black and a solution polymerized SBR. Japanese Unexamined Patent Publication (Kokai) No. 10-237230 discloses a method of using a wet master batch of carbon black and an emulsion polymerized SBR. Japanese Unexamined Patent Publication (Kokai) No. 2000-336208 discloses using and mixing carbon black and low viscosity low Tg SBR.

As explained above, to reduce the fuel consumption of a car etc., it has been proposed to improve the balance of the tan δ of tire tread rubber. Specifically, compositions or divided mixing of the formulation ingredients, the use of end-modified rubber, etc. have been proposed. However, such proposals are still insufficient. Further improvements are desirable. Here, improvement of the temperature dependency of the tan δ means a greater temperature dependency of the tan δ at 0° C. and 60° C. For example, by divided mixing, the fuel consumption, temperature dependency of the tan δ, and abrasion resistance are improved. However, at the same time, the process is inconvenienced due to the increase of the mixing step. Further, in divided mixing, when using silica or rubber having a high molecular weight, the load on the processability and the process becomes larger.

Further, the preparation of an NR-based wet master batch and a rubber composition using the same have been proposed in Japanese National Publication (Tokuhyo) No. 2000-507892, WO99/16600, etc.

### SUMMARY OF THE INVENTION

Accordingly, an object of the present invention is to provide a rubber composition capable of overcoming the above problems in the prior art and to improve the temperature dependency of the tan δ of the vulcanized rubber and superior abrasion resistance, tensile strength, elongation at break, etc. and capable of being suitably used, for example, for a tire tread.

The present invention provides a rubber composition having improved abrasion resistance and high temperature side tan δ (i.e., rolling resistance) in a rubber formulation using natural rubber, in addition to the method of formulation of the above prior art and capable of being suitably used as, for example, a tire tread.

In accordance with the present invention, there is provided a rubber composition (COM) comprising (i) 100 parts by weight total amount of softening agent of not more than 80 parts by weight, and mixing in an internal mixer, of a starting rubber composed of (A) 40 to 120 parts by weight of an SBR-carbon black (CB) rubber composition having a weight ratio of (CB) having a nitrogen specific surface area (N₂SA) of at least 70 m²/g to at least one styrene-butadiene copolymer rubber (SBR) of 0.4 to 1, (B) 40 to 120 parts by weight of an NR-CB rubber composition having a weight ratio of carbon black (CB) having a nitrogen specific surface area (N₂SA) of at least 70 m²/g to natural rubber (NR) of 0.4 to 1, and (C) a butadiene rubber (BR) and/or styrene-butadiene copolymer rubber (SBR) having a Tg higher by at least 10° C. than the Tg of the SBR starting rubber in the SBR-CB rubber composition (A) and (ii) 80 parts by weight or less of a total softening agent, which are obtainable by mixing in an internal mixer, wherein said rubber composition having a ratio F_{MB}/F_{COM} of an average value F_{MB} of the concentration of CB based upon the total amount of rubber in the CB-containing rubber compositions (A) and (B) and a concentration F_{COM} of carbon black (CB) based upon the amount of rubber in the rubber composition (COM) of 1.2 to 3.0.

In accordance with the present invention, there is also provided a rubber composition comprising (i) a CB-containing natural rubber master batch, which is obtainable by mixing a natural rubber (NR) starting latex and carbon black (CB) in a water-based medium, followed by coagulating and drying, (ii) an additional starting rubber having a glass transition temperature (Tg) of −50° C. to −20° C. and (iii) silica in an internal mixer.

### DESCRIPTION OF THE PREFERRED EMBODIMENT

The constitution and action and effects of the present invention will now be explained in detail.

According to the first embodiment of the present invention, first, carbon black having a nitrogen specific surface area (N₂SA) of at least 70 m²/g, preferably at least 90 m²/g, in a weight ratio with respect to SBR of 0.4 to 1, preferably 0.6 to 1 and, further, if necessary, a process oil, a plasticizer, anti-aging agent, etc. were mixed to obtain an SBR-CB rubber composition (A). The SBR used here includes any SBR (emulsion polymerized or solution polymerized) conventionally used for rubber material members used for pneumatic tires, in particular, the cap tread, and is preferably an SBR having a styrene content included in the SBR of at least 10% by weight, a vinyl content of at least 20 mol %, and a molecular weight of at least 100,000 in terms of a weight average molecular weight. Further, as the carbon black, it is possible to use those having a nitrogen specific area of at least 70 m²/g, preferably at least 90 m²/g. The method of production of the SBR-CB rubber composition (A) in the present invention may be those disclosed in, for example, Japanese Unexamined Patent Publication (Kokai) No. 10-237230.

According to the present invention, carbon black in a weight ratio to NR of 0.4 to 1, preferably 0.6 to 1 and, further, if necessary, a process oil, a plasticizer, anti-aging agent, etc. were mixed to obtain an NR-CB rubber composition (B). Here, as the carbon black, it is possible to use those having a nitrogen specific surface area of at least 70 m²/g, preferably at least 90 m²/g. The method of production of the NR-CB rubber composition (B) in the present invention may be those method disclosed in, for example, Japanese Unexamined Patent Publication (Kokai) No. 2000-507892.

According to the present invention, the starting rubber (C) was mixed in 40 to 120 parts by weight of the SBR-CB rubber composition (A), preferably 49 to 116 parts by weight, and 40 to 120 parts by weight of the NR-CB rubber composition (B), preferably 116 to 49 parts by weight, to give a total amount of rubber of 100 parts by weight and give a total amount of a softening agent of 80 parts by weight or less.

The softening agent used in the present invention include any softening agent conventionally used in a rubber composition. Specifically, an aromatic process oil, paraffinic oil, etc. may be exemplified. The amount blended is 80 parts or less, preferably 10 to 50 parts by weight, by weight based upon 100 parts by weight of the total amount of rubber. If the amount blended is too large, the reinforcing ability of the rubber composition is decreased and therefore thus is not preferable.

According to the present invention, a starting rubber (C) composed of BR and/or SBR having a Tg at least 10° C. higher, preferably at least 20° C. higher, than the Tg of the starting SBR in the SBR-CB rubber composition (A) is added and mixed in an internal type mixer such as a Bambury mixer to obtain a rubber composition (COM). With a difference of Tg of less than 10° C., the desired effect in the temperature dependency of the tan δ is liable not to be obtained and therefore this is not preferable.

As the starting rubber (C), there is no particular limitation so long as the glass transition temperature is satisfied. For example, it is possible to use any emulsion polymerized or solution polymerized polybutadiene, styrene-butadiene copolymer, etc.

The amount of the starting rubber blended is an amount giving a total amount of rubber of 100 parts by weight and a softening agent of not more than 80 parts by weight. By kneading the ingredients in an internal type mixer, it is possible to obtain a desired rubber composition.

According to the present invention, preferably the ratio F_{MB}/F_{COM} of the average value F_{MB} of the concentration of CB based upon the total amount of rubber in the rubber compositions (A) and (B) and the concentration F_{COM} of carbon black to the rubber in the rubber composition (COM) after kneading in an internal type mixer is 1.2 to 3.0, more preferably 1.3 to 2.0. If the ratio is too small, the desired effect in the temperature dependency of the tan δ is liable not to be obtained, and therefore this is not preferred. Conversely, if too large, the processability deteriorates, and therefore this is also not preferred.

The SBR in the SBR-CB rubber composition (A) of the present invention is preferably an emulsion polymerized SBR having a styrene content of 30% by weight or less. If the styrene content is too large, the Tg of the SBR itself rises and the difference of Tg becomes less than 10° C., and therefore this is not preferred.

The carbon blacks used in the rubber compositions (A) and (B) of the present invention may be the same or different. It is possible to use any carbon black which has been used for rubber compositions for tires in the prior art.

On the other hand, the SBR in the rubber composition (C) of the present invention has a styrene content of 20 to 50% by weight, preferably 30 to 50% by weight. If the styrene content is too small, the Tg of the SBR itself is decreased and the difference of the Tg becomes less than 10° C., and therefore this is not preferable. Conversely, if the styrene amount is too large, the rubber molecules become rigid and the balance of the elongation and strength of the rubber material deteriorates, and therefore this is again not preferable. Further, in the case of SBR in the rubber composition (C) of the present invention, in particular the SBR by the solution polymerization method, the vinyl content in the rubber is 10 to 70 mol %, preferably 30 to 70 mol %, in the butadiene portion. If the amount of vinyl is too small, the Tg of the SBR itself is decreased and the Tg difference becomes less than 70° C., and therefore this is not preferred. Conversely, if the amount of vinyl is too large, the SBR originally insoluble with the NR becomes soluble, and therefore the tan δ temperature dependency deteriorates. This is also not preferred.

The rubber composition according to the present invention may use, in addition to the above essential ingredients, a vulcanization agent such as sulfur, a vulcanization accelerator, vulcanization retardant, anti-aging agent, wax, or other rubber chemical or other general use ingredients. The amounts used may be made those used in the past.

According to the second embodiment of the present invention, the desired rubber composition is obtained by mixing, into a master batch obtained by mixing a natural rubber (NR) latex and carbon black (CB) in a water-based medium, an additional starting rubber having a Tg higher than NR, in particular a Tg of −50° C. to −20° C., and silica. By mixing, into the CB-containing NR master batch, a high Tg rubber superior in tan δ temperature dependency and silica in this way, compared with a rubber composition obtained by mechanical mixing, without using a master batch, it is possible to reduce the interaction of the carbon black with the high Tg rubber matrix, possible to improve the high temperature side tan δ (i.e., rolling resistance) and abrasion resistance, and possible to obtain a rubber composition having an improved abrasion resistance even compared with use of a master batch obtained by mechanical mixing.

The carbon black for the CB-containing NR master batch according to the present invention may be any carbon black generally used for tires in the past, but preferably a CB-containing NR master batch can be obtained by mechanically mixing in a water-based medium preferably 60 to 100 parts by weight, more preferably 70 to 100 parts by weight, of carbon black having a nitrogen specific surface area (N₂SA) of at least 70 m²/g, preferably at least 80 m²/g, based upon 100 parts by weight of the natural rubber latex (in terms of a solid content). This CB-containing NR master batch may have further blended in it, if necessary, a process oil, plasticizer, anti-aging agent, etc. As specific methods of preparation of the CB-containing NR master batch, the methods disclosed Japanese Unexamined Patent Publication (Kokai) No. 48-96636 and No. 58-152031, Japanese National Publication (Tokuhyo) No. 2000-507892, etc. may be used.

According to the second embodiment of the present invention, additional starting rubber is blended into the CB-containing NR master batch in an amount of preferably 10 to 60 parts by weight, more preferably 30 to 60 parts by weight, based upon 100 parts by weight of the total weight of the rubber in the finally synthesized rubber composition. If the amount of the additional starting rubber is too small, the effect of the high Tg rubber having the superior tan δ temperature dependency tends to be lost and the high temperature side tan δ is liable not to become sufficiently low. Conversely, if too large, the amount of the NR is largely decreased and the breaking properties are deteriorated.

The additional starting rubber blended into the CB-containing master batch according to the present invention are, for example, various types of styrene-butadiene copolymer rubber, vinyl-butadiene copolymer rubber, styrene-isoprene-butadiene copolymer rubber, and other diene-based rubbers. Preferably, an SBR obtained by emulsion polymerization and/or solution polymerization are used.

According to the present invention, to achieve both the reinforcing property of the additional starting rubber and the low energy loss, preferably 10 to 40 parts by weight of silica is blended into the above CB-containing NR master batch based upon 100 parts by weight of the total rubber. AS the silica, it is possible to blend any silica generally blended into rubber compositions, in particular for pneumatic tires, in the past, but preferably it is wet type silica having an N₂SA of at least 80 m²/g, more preferably at least 120 m²/g.

According to the present invention, it is possible to blend the same or different carbon black as the above in the CB-containing NR master batch, but the amount blended is preferably a maximum 20 parts by weight based upon 100 parts by weight of rubber in the final rubber composition. According to the present invention, it is preferable to make the entire amount of the fillers such as the carbon black and silica blended not more than 90 parts by weight based upon 100 parts by weight of the total rubber. If the amount blended is too large, the processability of the rubber tends to deteriorate.

The rubber composition according to the present invention may use, in addition to the above essential ingredients, a vulcanization agent such as sulfur, a vulcanization accelerator, vulcanization retardant, anti-aging agent, wax, or other rubber chemical or other general use ingredients. The amounts used may be made those used in the past.

### EXAMPLES

The present invention will now be explained in further detail by Examples, but of course the scope of the present invention is not limited to these Examples.

### Examples I-1 to I-7, Standard Example I-1 and Comparative Examples I-1 to I-4

The rubber compositions of the formulations shown in Table I-1 were prepared and evaluated in physical properties. Note that the formulations of the Master Batches I-1 to I-6 used in the Standard Example I-1, Examples, and Comparative Examples were as follows:

Formulation of Master Batch 1

Starting rubber latex: Emulsion polymerized SBR latex having a styrene content of 36%, a vinyl content (in BR ingredient) of 16%, a glass transition temperature of −36° C., and a weight average molecular weight of 720,000

Carbon black N339: Made by Tokai Carbon, Seast KH

Oil: Aromatic process oil

Blending ratio: Rubber latex/carbon black/oil=70/65/30

Formulation of Master Batch 2

Starting rubber latex: Natural rubber latex having a weight average molecular weight of 1,000,000

Carbon black N339: Made by Tokai Carbon, Seast KH

Oil: Aromatic process oil

Blending ratio: Rubber latex/carbon black/oil=70/65/30

Formulation of Master Batch 3

Starting rubber: 37.5 phr oil extended emulsion polymerized SBR having a styrene content of 36%, a vinyl content (in BR ingredient) of 16%, a glass transition temperature of −36° C., and a weight average molecular weight of 720,000

Carbon black N339: Made by Tokai Carbon, Seast KH

Oil: Aromatic process oil

Blending ratio: Oil extended rubber/carbon black/oil=96.25/65/3.75

Formulation of Master Batch 4

Starting rubber: Natural rubber having a weight average molecular weight of 1,000,000

Carbon black N339: Made by Tokai Carbon, Seast KH

Oil: Aromatic process oil

Blending ratio: Rubber/carbon black/oil=70/65/30

Formulation of Master Batch 5

Starting rubber latex: Emulsion polymerized SBR latex having a styrene content of 36%, a vinyl content (in BR ingredient) of 16%, a glass transition temperature of −36° C., and a weight average molecular weight of 720,000

Carbon black N339: Made by Tokai Carbon, Seast KH

Oil: Aromatic process oil

Blending ratio: Rubber latex/carbon black/oil=90/65/30

Formulation of Master Batch 6

Starting rubber latex: Natural rubber latex having a weight average molecular weight of 1,000,000

Carbon black N339: Made by Tokai Carbon, Seast KH

Oil: Aromatic process oil

Blending ratio: Rubber latex/carbon black/oil=90/65/30

Method of Mixing Master Batches 1, 2, 5, and 6

A rubber latex aqueous solution, carbon black suspension aqueous solution, and oil soap emulsion were adjusted to a predetermined formulation and simultaneously mixed and stirred to disperse them uniformly. Next, the mixture was coagulated by an acid etc., dehydrated, and dried.

Method of Mixing Master Batches 3 and 4

The rubber, carbon black, and oil were blended in predetermined amounts and mechanically mixed in an internal mixer. The mixture was formed into a sheet by a roll mill.

Preparation of Samples

The ingredients shown in Table I-1 except for the sulfur and vulcanization accelerator were mixed in a 1.8 liter Bambury mixer for 3 to 5 minutes and discharged when reaching 165±5° C. Next, the vulcanization accelerator and sulfur were mixed by an 8-inch open roll to obtain a rubber composition.

Each sample composition obtained was press vulcanized in a 15×15×0.2 cm mold at 160° C. for 20 minutes to prepare a desired test piece which was then evaluated for vulcanized physical properties. The results are shown in Table I-1.

The test methods for the vulcanized physical properties of the compositions obtained in the Examples are as follows:

1) 300% deformation stress, breaking strength, and elongation at break: Measured according to JIS K 6251 (dumbbell No. 3 shape)

2) tan δ: Measured by a viscoelasticity device made by Toyo Seiki Seisakusho, that is, a Rheograph Solid, at 20 Hz, an initial elongation of 10%, and a dynamic strain of 2% (sample width 5 mm, temperature 0° C. and 60° C.).

3) Abrasion resistance: Measured by a Lambourn abrasion tester and indicated by the reduction in weight by abrasion indexed by the following method:

Abrasion resistance(index)=[(Reduction in weight in test piece of Comparative Example I-7)/(Reduction in weight at individual test pieces)]×100

TABLE I-1

| | Stan- | | | | | | | | | | | |
|---|---|---|---|---|---|---|---|---|---|---|---|---|
| | dard | Comp. | | | | Comp. | | | | Comp. | | Comp. |
| | Ex. I-1 | Ex. I-1 | Ex. I-1 | Ex. I-2 | Ex. I-3 | Ex. I-2 | Ex. I-4 | Ex. I-5 | Ex. I-6 | Ex. I-6 | Ex. I-7 | Ex. I-4 |
| Formulation (parts by weight) | | | | | | | | | | | | |
| SBR1 | 45.0 | 45.0 | 45.0 | 45.0 | 45.0 | 45.0 | 45.0 | 45.0 | 45.0 | — | — | 15.0 |
| SBR2 | 96.25 | — | — | — | — | — | — | — | — | 41.25 | — | — |
| SBR2 | — | — | — | — | — | — | — | — | — | — | 45.0 | — |
| Master Batch 1 (SBR) | — | 165.0 | 115.5 | 82.5 | 49.5 | — | 82.5 | — | — | 82.5 | 82.5 | — |
| Master Batch 2 (NR) | — | — | 49.5 | 82.5 | 115.5 | 165.0 | — | 82.5 | — | 82.5 | 82.5 | — |
| Master Batch 3 (SBR) | — | — | — | — | — | — | — | 82.5 | 82.5 | — | — | — |
| Master Batch 4 (NR) | — | — | — | — | — | — | 82.5 | — | 82.5 | — | — | — |
| Master Batch 5 (SBR) | — | — | — | — | — | — | — | — | — | — | — | 92.5 |
| Master Batch 6 (NR) | — | — | — | — | — | — | — | — | — | — | — | 92.5 |
| Carbon black N339 | 65.0 | 65.0 | 65.0 | 65.0 | 65.0 | 65.0 | 65.0 | 65.0 | 65.0 | 65.0 | 65.0 | 65.0 |
| Zinc white | 3.0 | 3.0 | 3.0 | 3.0 | 3.0 | 3.0 | 3.0 | 3.0 | 3.0 | 3.0 | 3.0 | 3.0 |
| Stearic acid | 2.0 | 2.0 | 2.0 | 2.0 | 2.0 | 2.0 | 2.0 | 2.0 | 2.0 | 2.0 | 2.0 | 2.0 |
| Anti-aging agent 6C | 3.0 | 3.0 | 3.0 | 3.0 | 3.0 | 3.0 | 3.0 | 3.0 | 3.0 | 3.0 | 3.0 | 3.0 |
| Wax | 1.0 | 1.0 | 1.0 | 1.0 | 1.0 | 1.0 | 1.0 | 1.0 | 1.0 | 1.0 | 1.0 | 1.0 |
| Softening agent | 3.75 | 3.75 | 3.75 | 3.75 | 3.75 | 3.75 | 3.75 | 3.75 | 3.75 | 7.5 | 3.75 | 17.5 |
| Powdered sulfur | 1.8 | 1.8 | 1.8 | 1.8 | 1.8 | 1.8 | 1.8 | 1.8 | 1.8 | 1.8 | 1.8 | 1.8 |
| Vulcanization accelerator CZ | 1.9 | 1.9 | 1.9 | 1.9 | 1.9 | 1.9 | 1.9 | 1.9 | 1.9 | 1.9 | 1.9 | 1.9 |
| (Total amount) | 222.7 | 291.45 | 291.45 | 291.45 | 291.45 | 291.45 | 291.45 | 291.45 | 291.45 | 291.45 | 291.45 | 295.2 |
| Amount of all oil | 45.0 | 45.0 | 45.0 | 45.0 | 45.0 | 45.0 | 45.0 | 45.0 | 45.0 | 45.0 | 45.0 | 45.0 |
| F_{MAS} (Master Batch 1) | — | 0.93 | 0.93 | 0.93 | 0.93 | — | 0.93 | — | — | 0.93 | 0.93 | — |
| F_{MAS} (Master Batch 2) | — | — | 0.93 | 0.93 | 0.93 | 0.93 | — | 0.93 | — | 0.93 | 0.93 | — |
| F_{MAS} (MasterBatch 3) | — | — | — | — | — | — | — | 0.93 | 0.93 | — | — | — |
| F_{MAS} (MasterBatch 4) | — | — | — | — | — | — | 0.93 | — | 0.93 | — | — | — |
| F_{MAS} (MasterBatch 5) | — | — | — | — | — | — | — | — | — | — | — | 0.72 |
| F_{MAS} (Master Batch 6) | — | — | — | — | — | — | — | — | — | — | — | 0.72 |
| F_{MAS} (mean value) | — | 0.93 | 0.93 | 0.93 | 0.93 | 0.93 | 0.93 | 0.93 | 0.93 | 0.93 | 0.93 | 0.72 |
| F_{COM} | 0.65 | 0.65 | 0.65 | 0.65 | 0.65 | 0.65 | 0.65 | 0.65 | 0.65 | 0.65 | 0.65 | 0.65 |
| F_{MAS} (mean value)/F_{COM} | — | 1.43 | 1.43 | 1.43 | 1.43 | 1.43 | 1.43 | 1.43 | 1.43 | 1.43 | 1.43 | 1.11 |
| Vulcanized physical properties | | | | | | | | | | | | |
| 300% deformation stress/MPa | 7.8 | 7.9 | 7.8 | 7.5 | 6.9 | 6.5 | 8.2 | 7.5 | 8.5 | 7.5 | 8.1 | 7.4 |
| Breaking strength/MPa | 20.3 | 21.1 | 21.6 | 22.0 | 22.3 | 22.8 | 21.0 | 20.5 | 20.1 | 22.0 | 21.1 | 21.4 |
| Elongation at break/% | 610 | 578 | 602 | 618 | 633 | 657 | 568 | 581 | 548 | 625 | 608 | 611 |
| tan δ (0° C.) | 0.428 | 0.435 | 0.440 | 0.443 | 0.446 | 0.421 | 0.421 | 0.419 | 0.411 | 0.281 | 0.628 | 0.320 |
| tan δ (60° C.) | 0.216 | 0.179 | 0.168 | 0.158 | 0.154 | 0.143 | 0.165 | 0.163 | 0.160 | 0.134 | 0.154 | 0.142 |
| tan δ gradient (0° C./60° C.) | 1.98 | 2.43 | 2.61 | 2.80 | 2.90 | 2.94 | 2.55 | 2.57 | 2.57 | 2.10 | 4.08 | 2.25 |
| Abrasion resistance (index) | 113 | 119 | 120 | 132 | 123 | 115 | 135 | 132 | 140 | 119 | 130 | 117 |

SBR1: 50 phr oil extended emulsion polymerized SBR having a styrene content of 36%, a vinyl content (in BR ingredient) of 16%, a glass transition temperature of −36° C., and a weight average molecular weight of 720,000
SBR2: 37.5 phr oil extended emulsion polymerized SBR having a styrene content of 25%, a vinyl content (in BR ingredient) of 16%, a glass transition temperature of −51° C., and a weight average molecular weight of 620,000
SBR3: 50 phr oil extended emulsion polymerized SBR having a styrene content of 48%, a vinyl content (in BR ingredient) of 14%, a glass transition temperature of −21° C., and a weight average molecular weight of 680,000
Carbon Black N339: made by Tokai Carbon, Seast KH, N₂SA = 92 m²/g
Zinc oxide: Zinc Oxide No. 3
Stearic acid: Industrial Stearic Acid
Anti-aging Agent 6C: N-phenyl-N′-(1,3-dimethylbutyl) -p-phenylene diamine
Wax: Industrial Paraffin Wax
Softening agent: Aromatic process oil
Powdered sulfur: 5% extended powdered sulfur
Vulcanization accelerator CZ: N-cyclohexyl-2-benzothiazylsulfenamide

The Standard Example I-1 is an example of simultaneous mechanical mixing of SBR1 and SBR2 and carbon black in an internal mixer. Comparative Example I-1 is an example of mixing the SBR2 with the SBR1 in the master batch. By mixing the SBR2 at the master batch, the tan δ at 0° C. was greatly improved, the tan δ at 60° C. was reduced, and the tan δ became large compared with the Standard Example I-1. As opposed to this, Examples I-1 to I-3 are Examples of the case of use of the master batches of SBR and NR according to the present invention. By substituting these for the master match of NR, the breaking strength, elongation at break, abrasion resistance, and tan δ gradient were improved. Comparative Example I-2 is an example of the master batch of NR. Compared with Examples I-1 to I-3, the breaking properties and the tan δ gradient were improved, but the tan δ at 0° C. and the abrasion resistance fell.

Examples I-4 to I-6 are examples of use of master batches obtained by mechanical mixing by an internal mixer. Compared with Comparative Example I-1, the breaking properties, the tan δ gradient, and the abrasion resistance were improved, but compared with Example I-2, the breaking properties and the tan δ gradient fell.

Comparative Example I-3 is an example where the difference of Tg is less than 10° C. The tan δ at 60° C. was reduced, but the tan δ at 0° C. also dropped widely and the gradient deteriorated as well. Conversely, Example I-7 is an example of the case where the Tg difference is large and shows a large increase in the tan δ at 0° C. and a remarkable improvement in the tan δ gradient without causing a reduction in other physical properties.

Comparative Example I-4 is an example of the case where the F_{MAS}/F_{COM} value is not more than 1.2. A large drop in the tan δ gradient was seen.

As explained above, according to the present invention, it is possible to maintain or improve the breaking properties, the abrasion resistance, etc. while improving the temperature dependency of the tan δ and the absolute value of the tan δ.

### Example II-1, Standard Example II-1, and Comparative Examples II-1 to II-3

Rubber compositions of the formulations shown in Table II-2 (parts by weight) were prepared and evaluated for physical properties. Note that the formulation of the CB-containing NR master batch used in the formulations of the examples was as follows:

The method of preparation of this master batch is not limited to the method explained below.

This master batch was prepared from a 70 phr filler comprised of commercial grade N339 carbon black available from Cabot Corporation and Malaysian standard natural rubber field latex.

The complete formulation of the compound is shown in the following Table II-1. Further, as a typical example, there is a commercially available truck use tread tire known to have a superior resistance to vulcanization reversion during vulcanization.

TABLE II-1
Composition of Master Batch

| Ingredients | Parts by weight |
|---|---|
| Rubber | 100 |
| Carbon black | 70 |
| Anti-aging agent 6C | 0.7 |
| Aromatic process oil | 10 |

Details of the preparation of the master batch are shown below:

1. Preparation of carbon black slurry. Carbon black was mixed with pure water in a 1-liter flask provided with a stirrer. The pellets were broken up by the stirrer to form a slurry having 12.5% by weight carbon black.

2. Supply of latex. The latex was filled into a 1-liter flask. Before filling, an anti-aging emulsion was added to the latex. An anti-aging agent was prepared as a 15% by weight emulsion by adding potassium oleate in a ratio of 3:100 of the anti-aging agent and adjusting the pH to about 10 by potassium hydroxide. Further, 10 parts by weight of extender oil was emulsified by soap and added based upon 100 parts by weight of rubber.

3. Mixing of carbon black and latex. The carbon black slurry was transferred to a 3-liter coagulated rubber reaction flask provided with a stirrer. Latex was added to the carbon black slurry and mixed with it by the stirrer while suitably maintaining the ratio of the speed of supply of the latex mixture to the carbon black slurry. The desired 70 parts by weight, based upon 100 parts by weight of rubber, of the amount of the carbon black blended was obtained.

4. Dehydration. The wet crumbs discharged from the coagulated rubber reaction flask were dehydrated by a dehydration extruder. In the extruder, the wet crumbs were compressed and the water squeezed out from the crumbs.

5. Drying and cooling. The almost completely dehydrated crumbs were extruded and heated again. The extrusion temperature of the extruder was about 100° C., while the moisture content was about 0.5 to 1% by weight. The hot dried crumbs were rapidly cooled. The dried crumbs obtained included about 55.6% by weight of solid rubber and about 38.9% by weight of carbon black.

Preparation of Samples

The ingredients of the first mixing step shown in Table II-2 were mixed in a 1.8-liter Bambury mixer for 3 to 5 minutes. In Comparative Example II-3, S-SBR was further added at the second mixing step. The samples were discharged when reaching 165±° C. Next, the vulcanization accelerator and sulfur were mixed by an 8-inch open roll in the final mixing step to obtain a rubber composition.

Each sample composition obtained was press vulcanized in a 15×15×0.2 cm mold at 160° C. for 20 minutes to prepare a desired test piece which was then evaluated for vulcanized physical properties. The results are shown in Table II-1.

The test methods for the vulcanized physical properties of the compositions obtained in the Examples are as follows:

1) tan δ: Measured by a viscoelasticity device made by Toyo Seiki Seisakusho, that is, a Rheograph Solid, at 20 Hz, an initial elongation of 10%, and a dynamic strain of 2% (sample width 5 mm, temperature 60° C.)

2) Resilience: Measured by a Lupke resilience tester based on JIS K6255 at 40° C.

3) Abrasion resistance: Measured by a Lambourn abrasion tester and indicated by the reduction in weight by abrasion indexed by the following method:

Abrasion resistance(index)=[(Reduction in weight in test piece of Standard Example II-1)/(Reduction in weight at individual test pieces)]×100

TABLE II-2

| | | | (Parts by weight) | | |
|---|---|---|---|---|---|
| | Standard | Comp. | | Comp. | Comp. |
| | Ex. II-1 | Ex. II-1 | Ex. II-1 | Ex. II-2 | Ex. II-3 |
| First mixing step | | | | | |
| NR*1 | 100 | 50 | — | 50 | 50 |
| S-SBR*2 | — | 50 | 50 | 50 | — |
| CB-containing NR | — | — | 90.35 | — | — |
| master batch | | | | | |
| Silica*3 | — | — | 15 | 15 | — |
| Silane coupling | — | — | 1.5 | 1.5 | — |
| agent*4 | | | | | |
| DEG*5 | — | — | 0.75 | 0.75 | — |
| Carbon black*6 | 50 | 50 | — | 35 | 50 |
| Zinc oxide | 3.0 | 3.0 | 3.0 | 3.0 | 3.0 |
| Stearic acid | 2.0 | 2.0 | 2.0 | 2.0 | 2.0 |
| Anti-aging agent*7 | 3.0 | 3.0 | 2.65 | 3.0 | 3.0 |
| Paraffin wax | 2.0 | 2.0 | 2.0 | 2.0 | 2.0 |
| Aromatic process oil | 7.0 | 7.0 | 2.0 | 7.0 | 7.0 |
| Second mixing step | | | | | |
| S-SBR*2 | — | — | — | — | 50 |
| Silica*3 | — | — | — | — | 15 |
| Silane coupling | — | — | — | — | 1.5 |
| agent*4 | | | | | |
| DEG*5 | — | — | — | — | 0.75 |
| Final mixing step | | | | | |
| Sulfur*8 | 1.7 | 1.7 | 1.7 | 1.7 | 1.7 |
| Acc-NS*9 | 0.7 | 0.7 | 0.7 | 0.7 | 0.7 |
| Acc-DPG*10 | — | — | 0.2 | 0.2 | 0.2 |
| Vulcanized physical | | | | | |
| properties | | | | | |
| tan δ (60° C.) | 0.190 | 0.208 | 0.127 | 0.159 | 0.128 |
| (20 Hz, ±2%) | | | | | |
| Resilience (40° C.) | 50 | 48 | 58 | 54 | 58 |
| Abrasion resistance | 100 | 95 | 102 | 94 | 90 |
| (index) | | | | | |

*1Natural rubber SIR-20
*2Solution polymerized SBR (Nipol NS116 made by Nippon Zeon), Tg = −30° C.
*3Nipsil AQ made by Nihon Silica
*4Si69 made by Degussa-Huls
*5Diethyleneglycol
*6HAF grade carbon black (N339) made by Showa Cabot
*7Anti-aging agent 6C: N-phenyl-N′-(1,3-dimethylbutyl)-p-phenylenediamine
*8Powdered sulfur (5% oil extended)
*9Vulcanization accelerator NS: N-tert-butyl-2-benzothiazolylsulfenamide
*10Vulcanization accelerator DPG: diphenylguanine
*11 33.3% oil extended emulsion polymerized SBR (Nipol 9529 made by Nippon Zeon), Tg = −21° C.
*12 Solution polymerized SBR (Tufden 2000R made by Asahi Kasei), Tg = −67° C.

Table II-2 shows the results of the case of use of NR rubber (NR) and blends of the same with solution polymerized SBR S-SBR*2.

Standard Example II-1 is an example of all NR. Comparative Example II-1 is an example of substitution of half of the NR with solution polymerized SBR S-SBR*2 in Standard Example II-1. By substituting S-SBR*2, the tan δ at 60° C. rises and the resilience at 40° C. falls.

Comparative Example II-2 is an example of substitution of three-tenths or 15 parts by weight of the 50 parts by weight of carbon black with silica in Comparative Example II-1. Compared with Comparative Example II-1, the tan δ at 60° C. fell and the resilience at 40° C. was improved. Example II-1 according to the present invention exhibited a large reduction in the tan δ at 60° C. and an improvement in the resilience at 40° C. by blending in the CB-containing NR master batch.

In the present invention, the CB concentrates at the NR side, while the silica concentrates at the SBR side, so the constraint from the CB to the SBR is reduced and the high temperature side tan δ and resilience are improved.

Comparative Example II-3 aims at a similar effect by just mechanical mixing without using the NR master batch of the present invention. In the same way as in Example II-1, while the tan δ and resilience are improved, the abrasion resistance deteriorates. This shows the superiority of the use of the NR master batch of Example II-1. Table II-4 shows experiments with blends of NR and emulsion polymerized SBR E-SBR*11. Comparative Examples II-4, II-5, and II-7 and Example II-2 in Table II-3 are in similar relationships as with Comparative Examples II-1, II-2 and II-3 and Example II-1 in Table II-2.

By blending in the CB-containing NR master batch, it becomes possible to greatly improve the tan δ and resilience without causing a reduction in the abrasion resistance and other breaking properties.

Further, Example II-3 in Table II-3 is an example of the case of supply of carbon black from outside the NR master batch. Compared with Comparative Example II-6 exhibiting the same formulation, it is clear that this example is good.

Table II-4 shows the results of blends of solution polymerized SBR S-SBR*12 having Tg's outside of the scope of the present invention.

When using the E-SBR*12, there is almost no change in properties before and after use of the NR master batch. That is, there is no meaning at all in use of the master batch.

TABLE II-3

| | | | | (Parts by weight) | | |
|---|---|---|---|---|---|---|
| | Comp. | Comp. | Comp. | | | Comp. |
| | Ex. | Ex. | Ex. | Ex. | Ex. | Ex. |
| | II-4 | II-5 | II-6 | II-2 | II-3 | II-7 |
| First mixing step | | | | | | |
| NR*1 | 50 | 50 | 50 | — | — | 50 |
| E-SBR*11 | 75 | 75 | 75 | 75 | 75 | — |
| CB-containing NR master | — | — | — | 90.35 | 90.35 | — |
| batch | | | | | | |
| Silica*3 | — | 35 | 21 | 35 | 21 | — |
| Silane coupling agent*4 | — | 3.5 | 2.1 | 3.5 | 2.1 | — |
| DEG*5 | — | 1.75 | 1.05 | 1.75 | 1.05 | — |
| Carbon black*6 | 70 | 35 | 49 | — | 14 | 35 |
| Zinc oxide | 3.0 | 3.0 | 3.0 | — | — | 3.0 |
| Stearic acid | 2.0 | 2.0 | 2.0 | 3.0 | 3.0 | 2.0 |
| Anti-aging agent*7 | 3.0 | 3.0 | 3.0 | 2.0 | 2.0 | 3.0 |
| Paraffin wax | 2.0 | 2.0 | 2.0 | 2.65 | 2.65 | 2.0 |
| Aromatic process oil | 5.0 | 5.0 | 5.0 | 2.0 | 2.0 | 5.0 |
| Second mixing step | | | | | | |
| E-SBR*11 | — | — | — | — | — | 75 |
| Silica*3 | — | — | — | — | — | 35 |
| Silane coupling agent*4 | — | — | — | — | — | 3.5 |
| DEG*5 | — | — | — | — | — | 1.75 |
| Final mixing step | | | | | | |
| Sulfur*8 | 2.0 | 2.0 | 2.0 | 2.0 | 2.0 | 2.0 |
| Acc-NS*9 | 2.0 | 2.0 | 2.0 | 2.0 | 2.0 | 2.0 |
| Acc-DPG*10 | — | 0.5 | 0.5 | 0.5 | 0.5 | 0.5 |
| Vulcanized physical | | | | | | |
| properties | | | | | | |
| tan δ(60° C.) (20 Hz, | 0.283 | 0.177 | 0.211 | 0.159 | 0.170 | 0.161 |
| ±2%) | 34 | 46 | 41 | 49 | 47 | 48 |
| Resilience (40° C.) | 100 | 95 | 99 | 104 | 108 | 92 |
| Abrasion resistance | | | | | | |
| (index) | | | | | | |

TABLE II-4

(Parts by weight)

| | Comp. | Comp. |
|---|---|---|
| | Ex. II-8 | Ex. II-9 |
| First mixing step | | |
| NR*1 | 50 | — |
| S-SBR*12 | 50 | 50 |
| CB-containing NR master | — | 90.35 |
| batch | | |
| Silica*3 | 15 | 15 |
| Silane coupling agent*4 | 1.5 | 1.5 |
| DEG*5 | 0.75 | 0.75 |
| Carbon black*6 | 35 | — |
| Zinc oxide | 3.0 | — |
| Stearic acid | 2.0 | 3.0 |
| Anti-aging agent*7 | 3.0 | 2.0 |
| Paraffin wax | 2.0 | 2.65 |
| Aromatic process oil | 5.0 | 2.0 |
| Second mixing step | | |
| E-SBR*11 | — | — |
| Silica*3 | — | — |
| Silane coupling agent*4 | — | — |
| DEG*5 | — | — |
| Final mixing step | | |
| Sulfur*8 | 2.0 | 2.0 |
| Acc-NS*9 | 2.0 | 2.0 |
| Acc-DPG*10 | 0.5 | 0.5 |
| Vulcanized physical | | |
| properties | | |
| tan δ (60° C.) (20 Hz, ±2%) | 0.170 | 0.172 |
| Resilience (40° C.) | 52 | 52 |
| Abrasion resistance | 100 | 101 |
| (index) | | |

1. A rubber composition (COM) comprising (i) 100 parts by weight of a starting rubber composed of (A) 40 to 120 parts by weight of an SBR-carbon black (CB) rubber composition having a weight ratio of CB having a nitrogen specific surface area (N₂SA) of at least 70 m²/g to at least one styrene-butadiene copolymer rubber (SBR) of 0.4 to 1, (B) 40 to 120 parts by weight of an NR-CB rubber composition having a weight ratio of carbon black (CB) having a nitrogen specific surface area (N₂SA) of at least 70 m²/g to natural rubber (NR) of 0.4 to 1, and (C) a butadiene rubber (BR) and/or styrene-butadiene copolymer rubber (SBR) having a Tg higher by at least 10° C. than the Tg of the SBR starting rubber in the SBR-CB rubber composition (A) and (ii) 80 parts by weight or less of a total softening agent, which are obtainable by mixing in an internal mixer, said rubber composition having a ratio F_{MB}/F_{COM} of an average value F_{MB} of the concentration of CB based upon the total amount of rubber in the CB-containing rubber compositions (A) and (B) and a concentration F_{COM} of carbon black (CB) based upon the amount of rubber in said rubber composition (COM) of 1.2 to 3.0.

2. A rubber composition as claimed in claim 1, wherein said SBR-CB rubber composition (A) is a rubber composition obtainable by coagulating, dehydrating, and drying a rubber latex mixture having a weight ratio of carbon black (CB) to the SBR starting latex of 0.4 to 1, in terms of a solid content.

3. A rubber composition as claimed in claim 1, wherein said NR-CB rubber composition (B) is a rubber composition obtainable by coagulating, dehydrating, and drying a rubber latex mixture having a weight ratio of carbon black (CB) to the NR starting latex of 0.4 to 1, in terms of a solid content.

4. A rubber composition as claimed in claims 1, wherein the starting rubber (C) is SBR produced by solution polymerization and/or emulsion polymerization.

5. A pneumatic tire using a rubber composition according to claims 1 to form a cap tread.

6. A rubber composition comprising (i) a carbon black (CB)-containing natural rubber master batch which is obtainable by mixing a natural rubber (NR) starting latex and carbon black (CB) in a water-based medium, followed by coagulating and drying, (ii) an additional starting rubber having a glass transition temperature (Tg) of −50° C. to −20° C. and (iii) silica, wherein the components (i), (ii) and (iii) are obtainable by mixing in an internal mixer.

7. A rubber composition as claimed in claim 6, wherein said CB-containing natural rubber master batch includes 60 to 100 parts by weight of CB based upon 100 parts by weight of the NR starting latex, in terms of a solid content.

8. A rubber composition as claimed in claim 6, wherein the amount of the additional starting rubber in the CB-containing natural rubber master batch is 10 to 60 parts by weight based upon 100 parts by weight of the total weight of the rubber in the final rubber composition, the total amount of CB is 30 to 70 parts by weight, the amount of the silica is 10 to 40 parts by weight based upon 100 parts by weight of the total weight of the rubber, and the amount of all fillers is 90 parts by weight or less.

9. A rubber composition as claimed in claim 7, wherein said starting rubber is a styrene-butadiene copolymer rubber (SBR) obtained by solution polymerization and/or emulsion polymerization.

10. A rubber composition as claimed in claim 6, further including a sulfur-containing silane coupling agent.

11. A pneumatic tire comprising a rubber member using a rubber composition according to claim 7.
